(19) United States
(12) Patent Application Publication
(10) Pub. No.: US 2025/0240213 A1
(43) Pub. Date: Jul. 24, 2025

(54) MULTI-LAYER CONFIGURATION FOR COMPUTATION ENGINE INTEGRATION IN DISTRIBUTED COMPUTING SYSTEMS

(71) Applicant: ADP, Inc., Roseland, NJ (US)

(72) Inventors: Lukas KERSTING, Porto Alegre (BR); Alisson SALIN, Porto Alegre (BR); Fabio PFEIFF, Porto Alegre (BR); Mariangela Vanzin, Porto Alegre (BR)

(73) Assignee: ADP, Inc., Roseland, NJ (US)

(21) Appl. No.: 19/034,245

(22) Filed: Jan. 22, 2025

Related U.S. Application Data
(60) Provisional application No. 63/624,138, filed on Jan. 23, 2024.

(51) Int. Cl. H04L 41/0894

(52) U.S. Cl. CPC H04L 41/0894

(57) ABSTRACT

A system can receive, from a source application, input data corresponding to a predefined data schema. The system can identify, based on the input data, a plurality of policy configurations, where each policy configuration includes a first layer defining a first subset of policies, a second layer defining a second subset of policies, and a third layer defining data associated with a profile data structure. The system can map the input data to input fields defined within the first layer, the second layer, and the third layer of each policy configuration. The system can select, in response to mapping the input data to the input fields, a policy configuration for a target engine. The system can generate, based on the policy configuration, executable instructions for the target engine. The system can transmit the executable instructions to the target engine to cause the target engine to execute a network operation.

### CROSS-REFERENCE TO RELATED APPLICATIONS

This application claims the benefit of and priority, under 35 U.S.C. § 119, to U.S. Provisional Application No. 63/624,138, filed Jan. 23, 2024, the entirety of which is hereby incorporated by reference herein.

### TECHNICAL FIELD

This application is generally related to computing technology and, more particularly, to multi-layer configuration for computation engine integration in distributed computing systems.

### BACKGROUND

Distributed computing systems often integrate multiple computation engines or components to perform complex network operations. As these systems grow in scale, with an increasing number of interdependent computational components, efficiently configuring and integrating the various components becomes challenging. This complexity introduces risks of errors, delays, or inefficiencies in the overall system performance.

### SUMMARY

Aspects of the technical solutions described herein address the challenges of integrating computation engines in distributed computing systems. Efficiently configuring and managing the deployment of various interdependent computational components at scale introduces significant technical challenges. For example, mapping input data and parameters between heterogeneous computation engines with incompatible data formats and structures, as well as determining the frequency and format at which computation engines consume or process information, can be computationally intensive. Additionally, identifying and incorporating data elements for computation engines, particularly in scenarios where existing datasets are incomplete or incompatible, escalates operational complexity. These technical complexities are further compounded by the demand to preserve hierarchical relationships and dependencies across multi-layered configuration settings. Moreover, coordinating the proper sequencing of computation engine executions, often involving intricate workflows and interdependent data paths, while maintaining end-to-end data integrity presents additional technical challenges. The lack of seamless integration and processing capabilities can result in inefficiencies, leading to suboptimal system performance and latency in executing distributed network operations.

The technical solutions described herein address these and other technical challenges by implementing a multi-layer configuration framework for computation engine integration in distributed computing systems. The distributed computing systems incorporate middleware to standardize and streamline the integration of heterogeneous computation engines. The middleware includes modular data transformation components configured to execute generalized and specialized data conversion processes to address incompatibilities in data formats and structures among computation engines. Additionally, the middleware employs schema mapping algorithms to facilitate the alignment and translation of data elements across disparate schemas. The middleware incorporates a policy configuration framework, where each configuration includes multiple layers, such as a first layer defining general policies, a second layer specifying domain-specific policies, and a third layer associating data with profile data structures. The policy configuration framework provides a structured and extensible architecture for defining, managing, and applying rules and logic governing data processing, engine selection, or execution flow within the distributed systems. The middleware further manages data ingestion pipelines to regulate the frequency, format, and delivery of data to computation engines. These pipelines support diverse data processing techniques, including batch-based workflows and real-time streaming, and are adaptable to various data transmission protocols and delivery mechanisms.

The technical solutions can automate data discovery and integration services. For example, the middleware identifies and retrieves data elements from external data sources. The middleware incorporates the data elements into computation engine workflows by transforming and aligning them with the data formats and structures compatible with target engines. The middleware implements data validation and quality assurance mechanisms to maintain compatibility with the target engine's specifications. The middleware identifies and selects policy configurations based on input data and predefined criteria to define execution parameters for computation engines. The selection of policy configurations enhances the system's adaptability and responsiveness to varying data inputs. For each computation engine, a set of execution parameters and operational rules is defined, specifying how the computation engine performs network operations or computational calculations within the context of the multi-layered configuration. The operational rules, managed by the middleware, preserve hierarchical relationships and dependencies across configuration layers (e.g., general and domain-specific) to provide consistent application of computational logic and maintain end-to-end integrity.

The technical solutions can implement coordination among the middleware, computing systems, and source applications to streamline data integration and processing across distributed computing environments. The middleware platform interacts with computing systems and source applications through application programming interfaces (APIs) to manage execution and maintain data integrity. This coordination allows the middleware to retrieve, validate, and process data from various systems while adhering to established communication protocols. The middleware sequences computation engine executions based on predefined workflows and data dependencies, defining the order of operations to align data transformations, validations, and computations, among others. The middleware manages interdependencies between computation engines, propagating data updates consistently across the distributed system and minimizing discrepancies. The technical solutions further incorporate architectures to address execution exceptions, such as retry logic, dynamic sequence adjustments, and real-time or near real-time notifications, to maintain system operations and preserve data consistency. The technical solutions described herein provide a scalable and robust framework for integrating computation engines in distributed computing systems.

An aspect of the technical solutions described herein is directed to a system. The system includes one or more processors coupled with memory. The system can receive, from a source application, input data corresponding to a predefined data schema. The system can identify, based on the input data, a plurality of policy configurations. Each policy configuration can include a first layer defining a first subset of policies, a second layer defining a second subset of policies, and a third layer defining data associated with a profile data structure. The system can map the input data to input fields defined within the first layer, the second layer, and the third layer of each policy configuration. The system can select, in response to mapping the input data to the input fields, a policy configuration for a target engine. The system can generate, based on the policy configuration, executable instructions for the target engine. The system can transmit the executable instructions to the target engine to cause the target engine to execute a network operation.

The predefined data schema can include at least one of a comma-separated value (CSV) format, a tab-separated value (TSV) format, a fixed-width format, a JavaScript Object Notation (JSON) format, or an Extensible Markup Language (XML) format. The executable instructions can include data transformed from the input data corresponding to the predefined data schema into a format compatible with the target engine. The format compatible with the target engine can include at least one of a serialized data format or a binary data format. The system can generate the executable instructions to cause the target engine to execute the network operation in compliance with at least one of the first layer or the second layer of the policy configuration. The system can map the input data to the input fields defined within the first layer, the second layer, and the third layer of each policy configuration based at least on a hierarchical mapping. The hierarchical mapping can include at least one of a partial mapping, a dynamic mapping, a rule-based mapping, or semantic mapping. The system can identify, based on the policy configuration, the target engine to execute the network operation. The system can generate a notification upon determining that: a data element in the input data does not have a corresponding input field in any of the first, second, or third layers of the policy configuration, or the input field does not have a corresponding data element in the input data. The system can receive the input data from the source application via an application programming interface. The system can transmit the executable instructions to the target engine via an application programming interface.

An aspect of the technical solutions described herein is directed to a method. The method can include receiving, from a source application, input data corresponding to a predefined data schema. The method can include identifying a plurality of policy configurations. Each policy configuration can include a first layer defining a first subset of policies, a second layer defining a second subset of policies, and a third layer defining data associated with a profile data structure. The method can include mapping the input data to input fields defined within the first layer, the second layer, and the third layer of each policy configuration. The method can include selecting, in response to mapping the input data to the input fields, a policy configuration for a target engine. The method can include generating, based on the policy configuration, executable instructions for the target engine. The method can include transmitting the executable instructions to the target engine to cause the target engine to execute a network operation. The method can include providing, to the source application, output data of the network operation executed by the target engine.

The predefined data schema can include at least one of a comma-separated value (CSV) format, a tab-separated value (TSV) format, a fixed-width format, a JavaScript Object Notation (JSON) format, or an Extensible Markup Language (XML) format. The executable instructions can include data transformed from the input data corresponding to the predefined data schema into a format compatible with the target engine. The format compatible with the target engine can include at least one of a serialized data format or a binary data format. The method can include generating the executable instructions to cause the target engine to execute the network operation in compliance with at least one of the first layer or the second layer of the policy configuration. The method can include mapping the input data to the input fields defined within the first layer, the second layer, and the third layer of each policy configuration based at least on a hierarchical mapping. The hierarchical mapping can include at least one of a partial mapping, a dynamic mapping, a rule-based mapping, or semantic mapping. The method can include identifying, based on the policy configuration, the target engine to execute the network operation.

An aspect of this disclosure can be directed to a non-transitory computer readable medium, including one or more instructions stored thereon and executable by a processor. The processor can receive, from a source application, input data corresponding to a predefined data schema. The processor can identify, based on the input data, a plurality of policy configurations. Each policy configuration can include a first layer defining a first subset of policies, a second layer defining a second subset of policies, and a third layer defining data associated with a profile data structure. The processor can map the input data to input fields defined within the first layer, the second layer, and the third layer of each policy configuration. The processor can select, in response to mapping the input data to the input fields, a policy configuration for a target engine. The target engine can be identified based on the policy configuration. The processor can generate executable instructions for the target engine to cause the target engine to execute a network operation.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with some implementations.

FIG. 2 depicts an example method of multi-layer configuration for computation engine integration in distributed computing systems, in accordance with some implementations.

FIG. 3 depicts an example user interface, in accordance with some implementations.

FIG. 4 depicts a block diagram of an example computing system for implementing the embodiments of the present solution, including, for example, the system depicted in FIG. 1, and the method depicted in FIG. 2.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation. Several other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein implement a multi-layer configuration for computation engine integration in distributed computing systems. The system receives input data, structured according to a predefined schema, from a source application. Based on the input data, the system identifies multiple policy configurations. Each policy configuration includes three layers: a first layer defining a first subset of policies, a second layer defining a second subset of policies, and a third layer defining data associated with a profile data structure. The system then maps the received input data to input fields defined within the three layers of each candidate policy configuration. Based on the mapping, the system selects a specific policy configuration for a target engine. Using the selected policy configuration, the system generates executable instructions for the target engine and transmits these instructions to the target engine to cause the target engine to execute a network operation. The computing architecture, thus, facilitates the management of multi-layered configurations for computation engine integration.

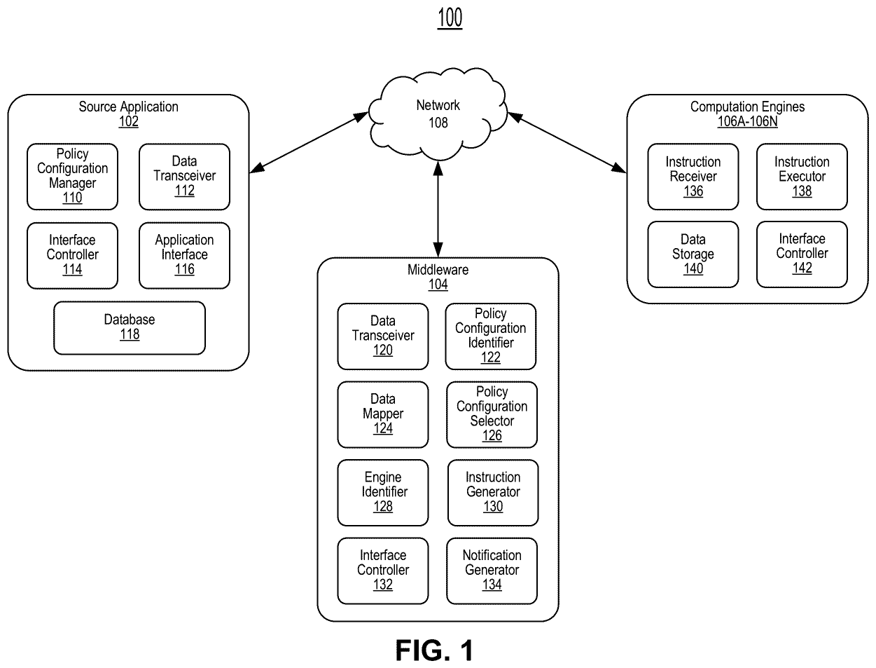

FIG. 1 depicts an example system according to one or more aspects of the technical solutions described herein. As illustrated by way of example in FIG. 1, a system 100 can include one or more of a source application 102, a middleware 104, and a computation engine 106. The middleware 104 can be operatively coupled to the source application 102 and one or more computation engines 106A-106N (which can also be referred to herein as a computation engine 106). For example, one or more components of the system 100 can communicate via network 108.

The source application 102 can be or include any script, file, program, application, set of instructions, or computer-executable code that can be configured to manage or automate data and processes associated with a computing infrastructure workforce. The source application 102 can correspond to a software system configured to manage and automate various human resources and workforce-related data and processes within a computing infrastructure. Such systems can be referred to or include as human capital management (HCM) systems or human resource management systems (HRMS). The source application 102 can manage recruitment, onboarding, talent development, personnel records, payroll processing, time tracking, and workforce analytics, among other functions. The specific functionalities associated with the source application 102 can vary depending on the implementation. The HCM 102 can include an application executing on each client system. The source application 102 can include or correspond to a web application, a server application, a resource, a desktop, or a file. In an aspect, the source application 102 can include a local application (e.g., local to a client system), a hosted application, a software-as-a-service (SaaS) application, a virtual application, a mobile application, and other forms of content. In another aspect, the source application 102 can include or correspond to applications provided by remote servers or third-party servers.

The middleware 104 can be or include any script, file, program, application, set of instructions, or computer-executable code that can be configured to transmit information to and receive information from the source application 102 and the computation engine 106. The middleware 104 can manage the deployment and configuration of interdependent computational components. The middleware 104 can perform data mapping and parameter translation between heterogeneous engines with incompatible data formats and structures. The middleware 104 can preserve hierarchical relationships and dependencies across multi-layered configuration settings. In some embodiments, the middleware 104 can be integrated directly within or alongside one or more computation engines 106. In such configurations, the middleware 104 can reside on the same server or within the same process space as the engine(s). In some embodiments, the middleware 104 can be deployed as a standalone component, separate from the computation engines 106. In such configurations, the middleware can reside on a separate server or in a different network segment, communicating with the engines over a network. The middleware 104 can communicate with the computation engines 106 via a well-defined application programming interface (API). These APIs can provide a standardized interface for data exchange and command execution. The APIs can utilize various protocols, such as HTTP (using RESTful or other API styles) or message queues, depending on the implementation.

The middleware 104 can manage the execution of computation engines 106 based on various triggers, events, or configurations. The middleware 104 can be configured to manage schedule setup for various HCM operations, such as regular payroll runs, by defining schedules (e.g., weekly, bi-weekly, monthly) and triggering the appropriate computation engine 106 at the scheduled times. This scheduling functionality can be based on calendar dates, recurring intervals, or other time-based criteria. The middleware 104 can cause the computation engine 106 to perform payroll proration to adjust an employee's pay for partial pay periods, such as when an employee starts or leaves employment mid-pay period. The middleware 104 can identify such situations based on input data, such as start and end dates, and can instruct the computation engine 106 to apply the appropriate proration calculations. The middleware 104 can interface with the source application 102 to retrieve schedules, deadlines, and other time-related information and monitor scheduled HCM operations.

The middleware 104 and computation engine 106 can implement a feedback mechanism in which the middleware 104 receives events from the computation engine 106. Such configuration can be relevant where the computation engine 106 receives a direct request from the source application 102. In such implementations, the computation engine 106, upon receiving the request, can generate an event (e.g., a message, a callback) that notifies the middleware 104. This event can cause the middleware 104 to perform data retrieval and format conversion, such that the computation engine 106 receives the data in a compatible format for processing.

The system 100 can utilize one or more computation engines 106A-106N (also referred to herein as a computation engine 106 or a target engine 106). Each computation engine 106 can be or include any script, file, program, application, set of instructions, or computer-executable code that can be configured to execute various network operations. The network operations can correspond to a range of HCM functions. For example, the network operations can include, but not limited to, payroll-related operations such as processing salary payments, calculating deductions and benefits, generating pay stubs, managing tax filings, and configuring direct deposit transactions. The network operations can also include time-related functions such as processing sick leave requests, vacation accruals, overtime calculations, managing time-off requests, tracking attendance, and managing other time-related data. In some embodiments, the computation engine 106 can be implemented internally within the middleware 104. In some embodiments, the computation engine 106 can be implemented externally to the middleware 104 and can be accessed via the network 108. The computation engine 106 can correspond to one or more engines depending on the implementation and the type of network operation. For example, the computation engine 106 can function as a leave management engine or time-off management engine to execute temporal or time-sensitive requests. Alternatively, or additionally, the computation engine 106 can function as a payroll engine to execute payroll-related requests. The computation engine 106 can also include other specialized engines for different HCM functions, such as performance management, benefits administration, or talent acquisition. In some embodiments, a single computation engine 106 can execute multiple types of network operations, while in other embodiments, dedicated engines can be used for specific tasks.

The network 108 can include any type or form of network. The geographical scope of the network 108 can vary widely, and the network 108 can include a body area network (BAN), a personal area network (PAN), a local-area network (LAN), e.g., Intranet, a metropolitan area network (MAN), a wide area network (WAN), or the Internet. The topology of the network 108 can be of any form and can include, e.g., any of the following: point-to-point, bus, star, ring, mesh, or tree. The network 108 can include an overlay network that is virtual and sits on top of one or more layers of other networks 108. The network 108 can be of any such network topology as known to those ordinarily skilled in the art capable of supporting the operations described herein. For example, the network 108 can be any form of computer network that can relay information between the source application 102, the middleware 104, and the computation engine 106. The network 108 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include application layer, transport layer, Internet layer (including, e.g., IPv6), or the link layer. The network 108 can include a type of a broadcast network, a telecommunications network, a data communication network, or a computer network.

The source application 102 can include, interface with, communicate with, or otherwise utilize a policy configuration manager 110. The policy configuration manager 110 can be or include any script, file, program, application, set of instructions, or computer-executable code that can be configured to manage policy configurations. Each policy configuration can define a specific set of rules and parameters governing various aspects of HCM processes. Each policy configuration can include one or more layers. A first layer of the policy configuration can define a first subset of policies, such as country-specific regulations or legal requirements. For example, the first layer can include, but not limited to, minimum wage laws, tax compliance rules (e.g., income tax, social security tax), statutory leave entitlements (e.g., maternity leave, sick leave, vacation time), mandatory retirement contribution calculations, overtime rules, and data privacy regulations. A second layer of the policy configuration can define a second subset of policies corresponding to client-related rules or company-specific procedures, such as pay schedules (e.g., weekly, bi-weekly, monthly), bonus structures, performance review processes, internal leave policies (e.g., bereavement leave, jury duty leave), expense reimbursement policies, and internal data access controls. A third layer of the policy configuration can define data associated with a profile data structure, which can include employee-related information or entity-related data. For example, the third layer can include, but not limited to, job titles, payroll classifications (e.g., exempt/non-exempt, full-time/part-time), work schedules, accrued benefits (e.g., vacation time, sick leave), pay rates, department or cost center assignments, and personal information such as contact details, emergency contacts, and bank account information for direct deposit.

The policy configuration manager 110 can dynamically adjust or reconfigure the order or application of the layers within a policy configuration. For example, the policy configuration manager 110 can cause client-specific policies defined in the second layer to be evaluated or applied prior to the country-specific regulations defined in the first layer. The policy configuration manager 110 can dynamically select certain layers based on the context of the network operation or specific criteria. For example, if a particular data element is not relevant to a specific operation, the policy configuration manager 110 can cause the corresponding layer or portions of that layer to be bypassed or ignored. The policy configuration manager 110 can be configured to generate a composite policy configuration by combining or merging layers from different policy configurations.

The source application 102 can include, interface with, communicate with, or otherwise utilize a data transceiver 112. The data transceiver 112 can be or include any script, file, program, application, set of instructions, or computer-executable code that can be configured to manage data exchange among the source application 102, the middleware 104, and the computation engine 106. The data transceiver 112 can transmit data associated with policy configurations to the middleware 104. In some embodiments, the data transceiver 112 can transmit raw or unprocessed data for calculations or processing to the computation engine 106. The data transceiver 112 can receive processed data, such as calculated payroll results or processed time-off requests, from the middleware 104. In some embodiments, the data transceiver 112 can receive processed data from the computation engine 106. The data transceiver 112 can be configured to maintain compatibility among the source application 102, the middleware 104, and the computation engine 106. The data transceiver 112 can implement error handling mechanisms to detect and manage data transmission errors. The data transceiver 112 can provide logging and auditing capabilities to track data exchange activities. The data transceiver 112 can implement security measures, such as encryption and authentication, to protect sensitive data during transmission.

The data transceiver 112 can transmit data corresponding to a predefined data schema to the middleware 104. A predefined data schema can define a structured format for data exchange, specifying the data elements, their data types, and their organization. The predefined data schema can include various formats, including, but not limited to, comma-separated value (CSV) format, where data is organized in rows and columns separated by commas; a tab-separated value (TSV) format, similar to CSV but using tabs as separators; a fixed-width format, where each data element occupies a fixed number of characters; JavaScript Object Notation (JSON) format, a lightweight data-interchange format using key-value pairs; or an Extensible Markup Language (XML) format, a markup language configured for encoding documents in a format that is both human-readable and machine-readable. For example, a predefined schema for employee data can specify fields such as employee ID (integer), first name (string), last name (string), hire date (date), and salary (decimal), defining the order and format in which this information is transmitted.

The source application 102 can include, interface with, communicate with, or otherwise utilize an interface controller 114. The interface controller 114 can be or include any script, file, program, application, set of instructions, or computer-executable code that can be configured to facilitate communication among the source application 102, the middleware 104, and the computation engine 106. The interface controller 114 can include hardware, software, or any combination thereof. The interface controller 114 can facilitate communication among the source application 102, the middleware 104, and the computation engine 106 via one or more communication interfaces. A communication interface can include, for example, an application programming interface (“API”) compatible with a particular component of the source application 102, the middleware 104, and the computation engine 106. The communication interface can provide a particular communication protocol compatible with a particular component of the source application 102, a particular component of the middleware 104, or a particular component of the computation engine 106. The interface controller 114 can be compatible with particular content objects and can be compatible with particular content delivery systems corresponding to particular content objects, structures of data, types of data, or any combination thereof. For example, the interface controller 114 can be compatible with the transmission of structured or unstructured data according to one or more metrics.

The source application 102 can execute an application that communicates with the middleware 104 or the computation engine 106. The application can present one or more application interfaces 116. The application interface 116 can include a set of rules or protocols that allow different software programs or systems to communicate with each other. The application interface 116 can provide user interfaces to facilitate interaction. Through the application interface 116, users can input information (such as employee data, leave requests, or payroll adjustments), view content (such as reports, dashboards, or employee profiles), or initiate actions (such as approving leave requests, processing payroll, or generating reports). The application interface 116 can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for single-touch or multi-touch input functionalities, thereby providing a more intuitive and responsive user experience.

The source application 102 can include, interface with, communicate with, or otherwise utilize a database 118. The database 118 can be a computer-readable memory that can store or maintain any of the information described herein. The database 118 can store data associated with the source application 102. The data associated with the source application 102 can include, but not limited to, employee information, payroll data, time and attendance records, and policy configurations. The database 118 can be implemented using various database technologies, such as relational databases (e.g., SQL databases), NoSQL databases, or other suitable data storage solutions. The database 118 can reside on one or more physical storage devices, such as hard disk drives, solid-state drives, or network-attached storage. The database 118 can be managed by a database management system. The database 118 can be implemented to provide efficient data access and retrieval. The database 118 can be implemented internally within the source application 102. The database 118 can be implemented externally to the source application 102, accessible via appropriate interfaces. In some embodiments, the database 118 can be distributed across multiple systems, such as in a cloud environment.

The database 118 can store or maintain one or more profile data structures. The profile data structure can include a structured representation of a user or an entity. A user can refer to an employee (e.g., a full-time employee, a part-time employee, a contractor) or other individual interacting with the system. An entity can refer to an organization, a department, a business unit, or other organizational structure. The database 118 can include relevant data for network operations, such as personal details (e.g., name, address, contact information), employment information (e.g., job title, hire date, department, employment status), compensation data (e.g., salary, bonuses, contribution allocations, pay rate), tax details (e.g., withholdings, filing status, tax identification number), banking information (e.g., account numbers, routing numbers), time and attendance data (e.g., accrued leave, time-off requests, work schedules), and other relevant attributes.

The database 118 can store data structured to represent the multiple layers of the policy configurations: a first layer for country-specific data (e.g., national identification numbers, tax codes, labor laws, statutory benefits), a second layer for client-specific data (e.g., company ID, organizational policies, project allocation codes, department-specific budget rules), and a third layer for individual profile data (e.g., employee ID, compensation details, accrued leave balances, personalized benefit selections). The database 118 can store data representing entities organized in a hierarchical structure, where one entity acts as a parent to multiple child entities (e.g., a company or an employer profile having a hierarchical relationship with department profiles, and department profiles having hierarchical relationships with employee profiles). The database 118 can also store metadata associated with each profile data structure or policy configuration, such as creation date, modification timestamps, data source, and ownership. These metadata attributes can facilitate management of compliance, contribution tracking, and updates, such that the profile data remains current and compliant with evolving standards.

The middleware 104 can include, interface with, communicate with, or otherwise utilize a data transceiver 120. The data transceiver 120 can be or include any script, file, program, application, set of instructions, or computer-executable code that can be configured to manage data exchange among the source application 102, the middleware 104, and the computation engine 106. The data transceiver 120 can be similar to, and include any of the structure and functionality of, the data transceiver 112 described in connection with the source application 102.

The middleware 104 can interact with the source application 102 via a defined application programming interface (API) to facilitate the transmission of input data relevant to HCM operations (e.g., employee information, leave requests, payroll updates). The interface controller 132 (on the middleware side) and the interface controller 114 (on the source application side) can manage this API interaction. The interface controller 114 can allow the data transceiver 112 within the source application 102 to function as an API client. The client (using the interface controller 114) can initiate communication with the middleware 104 by specifying the API endpoint (e.g., a uniform resource locator (URL) identifying the target service). In some embodiments, the API interaction can include defining the hypertext transfer protocol (HTTP) method (e.g., GET, POST, PUT, DELETE), specifying headers to provide metadata (e.g., content type, authentication credentials), and transmitting the payload including the input data (e.g., in JSON or XML format). On the middleware side, the data transceiver 120 can function as an API server or endpoint and receive these incoming requests.

The data transceiver 120 can transmit executable instructions, generated by the middleware 104, to the computation engine 106 to execute a network operation. The data transceiver 120 can interact with an interface controller 132 (on the middleware side) configured to establish and manage the communication channel. For example, if the computation engine 106 provides an API, the interface controller 132 (on the middleware side) and the interface controller 142 (on the computation engine side) can facilitate communication by structuring the data exchange according to the API's specifications. The data transceiver 120 can then transmit the formatted executable instructions to the computation engine 106 through the established communication channel.

The middleware 104 can include, interface with, communicate with, or otherwise utilize a policy configuration identifier 122. The policy configuration identifier 122 can be or include any script, file, program, application, set of instructions, or computer-executable code that can be configured to identify policy configurations, such as candidate policy configurations, for a given network operation. The candidate policy configurations can refer to potential policy configurations that can be applicable to a given network operation but have not yet been definitively selected. The policy configuration identifier 122 can receive input data from the source application 102 or the computation engine 106, depending on the implementation. The policy configuration identifier 122 can evaluate the input data using various techniques, such as pattern matching, rule-based logic, or database lookups, to determine which policy configurations are appropriate in the context of the network operation. The policy configuration identifier 122 can compare the input data against predefined patterns or templates. These patterns can specify combinations of data elements that correspond to certain policy configurations. For example, a pattern can be defined as “Employee Location=[Country] AND Request Type=Vacation,” which can map to corresponding policy configurations for that country. The policy configuration identifier 122 can implement regular expressions, string matching algorithms, or other pattern recognition techniques to identify the candidate policy configurations.

In some embodiments, the policy configuration identifier 122 can evaluate the input data against a set of rules defined by the policy configuration manager 110, and if the input data satisfies the conditions of a particular rule, the policy configuration identifier 122 can identify the associated policy configurations. For example, a rule can be “IF Employee Job Title=Manager THEN select Managerial Leave Policy.” These rules can be implemented using IF-THEN statements, decision trees, or other rule-based systems. In some embodiments, the policy configuration identifier 122 can query a database or lookup table maintained by the policy configuration manager 110, where input data elements are mapped to specific policy configurations. For example, a lookup table can map employee IDs to client IDs, and then another table can map client IDs to specific policy configurations. The policy configuration identifier 122 can use SQL queries, key-value lookups, or other database access methods to retrieve the candidate policy configurations.

The policy configuration identifier 122 can determine policy instance eligibility groups. In this regard, the policy configuration identifier 122 can evaluate which employees or entities are eligible for specific instances of a policy. For example, an organization can define different vacation policies for full-time employees, part-time employees, and contractors. The policy configuration identifier 122 can use the employee's employment status (full-time, part-time, or contractor), along with other attributes from the input data, to identify the applicable vacation policy instances that can be applied.

The middleware 104 can include, interface with, communicate with, or otherwise utilize a data mapper 124. The data mapper 124 can be or include any script, file, program, application, set of instructions, or computer-executable code that can be configured to map input data to input fields defined within each identified policy configuration. The input data can include details corresponding to a network operation, such as payroll-related operations and leave-related processes. The data mapper 124 can utilize the policy configurations identified by the policy configuration identifier 122, where each candidate policy configuration can include input fields organized into three layers: country-specific, client-specific, and profile-specific. The data mapper 124 can match data elements within the input data to corresponding input fields within each of the three layers of the candidate policy configurations. For example, the data mapper 124 can map input data elements to input fields with the same name or meaning, such as mapping an input data element “Employee ID” to an input field “Employee ID” in the profile-specific layer. The data mapper 124 can perform data transformations to make input data compatible with input fields, such as transforming a date format from “MM/DD/YYYY” to “YYYY-MM-DD,” depending on the implementation.

The data mapper 124 can implement a hierarchical mapping approach, which refers to a multi-stage or layered mapping process to manage complex relationships between input data and policy configuration fields, especially across the different layers of the policy configuration (country, client, and profile). The hierarchical mapping can include several techniques. For example, the hierarchical mapping can include partial mapping, where only relevant data elements are identified and mapped. The hierarchical mapping can include dynamic mapping, where mapping rules can change based on the input data or contextual factors, such as mapping “Location” based on the “Country” data element. The hierarchical mapping can include rule-based mapping, where the data mapper 124 applies predefined rules, such as “IF Employee Department=‘Sales’ THEN map ‘Commission Rate’ to input field ‘Sales Commission.’” The hierarchical mapping can include semantic mapping, where the data mapper 124 evaluates the meaning or context of data elements and input fields to provide accurate mapping, such as identifying that “Employee Number” and “Employee ID” refer to the same concept. After mapping the input data to the input fields of each candidate policy configuration, the data mapper 124 can cause one or more components of the middleware 104 to determine which policy configuration is the best match.

The middleware 104 can include, interface with, communicate with, or otherwise utilize a policy configuration selector 126. The policy configuration selector 126 can be or include any script, file, program, application, set of instructions, or computer-executable code that can be configured to select the most appropriate policy configuration from a set of candidate policy configurations based on the mapped data provided by the data mapper 124. The policy configuration selector 126 can receive the mapped input data, which specify the matching of input data elements to corresponding fields within each candidate policy configuration. The policy configuration selector 126 can evaluate the data to identify the best match using factors such as the number of successful mappings, the importance of specific mappings, and predefined prioritization rules, among others. For example, the policy configuration selector 126 can prioritize configurations with a higher number of successful mappings and assign greater weight to important mappings, such as “Employee ID,” over less significant mappings such as “Employee Nickname.” The policy configuration selector 126 can apply predefined prioritization rules, such as giving precedence to country-specific policies over client-specific policies in cases of conflict, or vice versa. In some cases, where multiple configurations satisfy the criteria or have similar scores, the policy configuration selector 126 can be configured to identify the most specific or relevant configuration based on predefined rules or priorities, or prompt for user input, depending on the implementation. The policy configuration selector 126 can determine and select a single definitive policy configuration to guide the computation engine 106 in executing the corresponding network operation.

The middleware 104 can include, interface with, communicate with, or otherwise utilize an engine identifier 128. The engine identifier 128 can be or include any script, file, program, application, set of instructions, or computer-executable code that can be configured to identify the appropriate computation engine 106 (or the target engine 106) to execute a given network operation. The engine identifier 128 can determine the appropriate computation engine 106 based on the selected policy configuration. For example, if the network operation is payroll-related (e.g., calculating salaries, processing bonuses, generating tax reports), the engine identifier 128 can select a payroll engine within the computation engine 106. The payroll engine can include specific algorithms, rules, and data structures for payroll calculations. If the network operation is temporal or time-sensitive (e.g., processing leave requests, managing time-off, managing country or employee onboarding requests), the engine identifier 128 can select a different engine within the computation engine 106, such as a leave management engine, time-off management engine, or a scheduling coordination engine, that can manage specific logic and data associated with different types of requests.

In some embodiments, the selected policy configuration can specify the appropriate computation engine 106. In some embodiments, the engine identifier 128 can implement a set of rules or a lookup table to map policy configurations or input data characteristics to specific engines. For example, a rule could state: “IF Policy Configuration Layer 2 (Client)=‘Client A’ AND Network Operation Type=‘Payroll’ THEN Select ‘Payroll Engine X.’” The engine identifier 128 can manage multiple computation engines 106 to execute a single network operation. In this regard, the engine identifier 128 can coordinate the execution of these engines and facilitate data exchange between them. The engine identifier 128 can manage engine availability and load balancing. For example, if a particular computation engine 106 is unavailable or overloaded, the engine identifier 128 can select an alternative engine or queue the operation for later processing. The engine identifier 128 can maintain a registry of available computation engines 106 and their capabilities to facilitate efficient engine selection.

The middleware 104 can include, interface with, communicate with, or otherwise utilize an instruction generator 130. The instruction generator 130 can be or include any script, file, program, application, set of instructions, or computer-executable code that can be configured to generate executable instructions for the computation engine 106 (or the target engine 106). The instruction generator 130 can generate these instructions based on the selected policy configuration, such that the computation engine 106 can operate in accordance with the defined rules and parameters. The instruction generator 130 can receive input from one or more sources, such as the input data provided by the source application 102, the selected policy configuration, and information about the computation engine 106, including its expected input format and available functions. The instruction generator 130 can then transform the input data to be provided to the computation engine 106 from its original format, defined by the predefined data schema, into a format compatible with the computation engine 106. For example, the instruction generator 130 can convert data types (e.g., strings to integers or dates to timestamps), restructure data elements into the desired order or structure, and serialize the data into formats such as JSON, XML, protocol buffers, or binary formats, depending on the performance requirements, data size, and capabilities of the computation engine 106.

Based on the transformed data and the selected policy configuration, the instruction generator 130 can generate executable instructions for the computation engine 106. These instructions can include function calls to exposed APIs with transformed data as arguments, scripts comprising the logic and data for computation engines 106 that interpret scripting languages, or bytecode or machine code directly executable by the computation engine 106. Once generated, the executable instructions can be transmitted via the data transceiver 120 to the computation engine 106 for execution. In a non-limiting example, if the network operation corresponds to payroll calculation, the instruction generator 130 can receive employee data such as salary, hours worked, and tax withholdings, along with a policy configuration defining tax rules. The instruction generator 130 can then transform the employee data into a format suitable for the payroll engine and generate instructions to call the payroll engine's calculation functions. These instructions can include the transformed data as input. The generated instructions can be formatted as a custom binary format compatible with the payroll engine to facilitate seamless execution of the network operation.

The instruction generator 130 can generate executable instructions to cause the computation engine 106 to execute a network operation in compliance with at least one of the first layer (country-specific policies) or the second layer (client-specific policies) of the policy configuration. The instruction generator 130 can receive the selected policy configuration as input, which organizes the rules and parameters into three layers: the first layer for country-specific policies (including regulations such as minimum wage laws, tax rates, and statutory leave entitlements), the second layer for client-specific policies (including internal pay scales, bonus structures, and company-specific leave policies), and the third layer for profile-specific data (including individual-specific details like employee ID, salary, and job title). These generated instructions are then transmitted to the computation engine 106 for execution.

The instruction generator 130 can maintain compliance with the first and second layers during the generation of instructions in various manners. In some embodiments, the instruction generator 130 can embed rules from these layers into the executable instructions, such as incorporating a validation check to confirm that no employee is compensated below the minimum wage defined in the first layer or embedding a bonus calculation formula specified in the second layer. In some embodiments, the instruction generator 130 can parameterize the instructions using data from these layers, such as utilizing tax rates from the first layer as input parameters for a tax calculation function within the engine. Similarly, client-specific vacation accrual rates from the second layer can be used to configure or define the leave management logic in the engine. The instruction generator 130 can generate instructions that include conditional logic based on the rules in the first and second layers. For example, the instructions can include an “IF” statement that validates an employee's location and then applies the appropriate country-specific tax rules (from the first layer). In some embodiments, the instruction generator 130 can prioritize one layer over another, such as giving precedence to more restrictive client-specific policies from the second layer over general country-specific regulations from the first layer, or vice versa. For example, if the first layer specifies a standard income tax rate of 10%, and the second layer specifies a 15% bonus tax rate for sales employees, the instruction generator 130 can generate instructions that apply the 15% rate for bonus calculations, overriding the general 10% rate for that specific scenario.

The middleware 104 can include, interface with, communicate with, or otherwise utilize an interface controller 132. The interface controller 132 can be or include any script, file, program, application, set of instructions, or computer-executable code that can be configured to facilitate communication among the source application 102, the middleware 104, and the computation engine 106. The interface controller 132 can be similar to, and include any of the structure and functionality of, the interface controller 114 described in connection with the source application 102.

The middleware 104 can include, interface with, communicate with, or otherwise utilize a notification generator 134. The notification generator 134 can be or include any script, file, program, application, set of instructions, or computer-executable code that can be configured to generate notifications related to data mapping inconsistencies or mismatches. The notification generator 134 can be configured to identify and report instances where the input data may not align with the expected structure defined by the policy configurations. The notification generator 134 can operate in conjunction with the data mapper 124. For example, during data mapping, if the data mapper 124 determines that a data element in the input data cannot be mapped to a corresponding input field within any of the three layers (country-specific, client-specific, or profile-specific) of the policy configurations, the data mapper 124 can cause the notification generator 134 to generate a corresponding notification. For example, if the input data includes a “Previous Employer” field, but none of the policy configuration layers define an input field for this information, the notification generator 134 can generate a notification indicating a missing input field. The notification generator 134 can be configured to generate a missing data element notification when an input field in the policy configuration does not have a corresponding data element in the input data, indicating that expected information is absent. For example, if the policy configuration requires an “Employee Start Date” but this information is missing from the input data, the notification generator 134 can generate a corresponding notification.

The notifications generated by the notification generator 134 can include detailed information such as the name of the missing data element or input field, the layer of the policy configuration where the issue was detected, a timestamp of detection, a severity level (e.g., warning or error), and contextual details such as the employee ID or request type. These notifications can be transmitted in various formats, including log entries, email alerts, or messages displayed in a user interface. Depending on the implementation, the notifications can be processed in different ways, such as being logged for auditing purposes, displayed to an administrator for review, or used to trigger corrective actions, such as requesting additional information from the user or updating the policy configuration.

The computation engine 106 can include, interface with, communicate with, or otherwise utilize an instruction receiver 136. The instruction receiver 136 can be or include any script, file, program, application, set of instructions, or computer-executable code that can be configured to receive executable instructions from the middleware 104. The communication between the middleware 104 and the computation engine 106 can be facilitated through a well-defined API managed by interface controllers. The API can specify endpoints or URIs, HTTP methods, and the structure and format of the exchanged data. On the middleware side, the interface controller 132 can generate API requests according to these specifications, including setting the HTTP method, headers (e.g., content-Type, authentication credentials), and the request body, including the instructions and data. On the computation engine side, the interface controller 142 can listen for incoming API requests on the defined endpoints. Upon receiving a request, the interface controller 142 can provide the request (including the instructions and data) to the instruction receiver 136.

The instruction receiver 136 can validate the format of the received instructions and determine whether the data conforms to the expected format, such as binary, JSON, or XML, depending on the implementation. In this regard, the instruction receiver 136 can perform schema validation, data type checking, and other format-specific checks to confirm correctness. If the format is invalid, the instruction receiver 136 can generate an error or reject the request. The instruction receiver 136 can determine the compatibility of the received instructions with the computation engine 106, such that the computation engine 106 supports the operations specified by the instructions. For example, if the instructions include a call to a function not implemented in the engine, the instruction receiver 136 can generate an error. The instruction receiver 136 can parse the instructions to extract the specific operations to be performed and the data to be used as input for those operations. In some embodiments, the instruction receiver 136 can transform the data types into a format suitable for the computation engine's core processing logic, such as converting strings to numbers, dates to timestamps, or performing other conversions.

The computation engine 106 can include, interface with, communicate with, or otherwise utilize an instruction executor 138. The instruction executor 138 can be or include any script, file, program, application, set of instructions, or computer-executable code that can be configured to interpret and execute the operations specified by the executable instructions. The instruction executor 138 can receive parsed or processed executable instructions from the instruction receiver 136. The instruction executor 138 can interpret the instructions to determine the operations to be performed and the associated data. The instruction executor 138 can execute the specified operations, which can vary depending on the network operation being performed. For payroll-related operations, the instruction executor 138 can perform calculations for gross pay, apply tax rules, access tax tables, and generate payroll reports, among others. For temporal or time-dependent operations, the instruction executor 138 can apply time-based rules, use date and time functions, and manage time-series data to calculate accrued leave or track attendance, among others. In some embodiments, the instruction executor 138 can format the results of these operations into a specific format, such as serializing them into JSON or XML or converting them into a binary format. The instruction executor 138 can cause the computation engine 106 to transmit the results back to the middleware 104.

The computation engine 106 can include, interface with, communicate with, or otherwise utilize a data storage 140. The data storage 140 can be similar to, and include any of the structure and functionality of, the database 118 described in connection with the source application 102. The data storage 140 can function as a local or internal data repository for the computation engine 106. The data storage 140 can store various types of data, including intermediate calculation results generated during multi-step computations such as payroll calculations (e.g., intermediate tax or deduction amounts), engine-specific data required by the engine's algorithms or logic (e.g., tax tables, lookup values, configuration parameters), and temporary or transient data used during the execution of specific operations. For payroll-related tasks, the data storage 140 can maintain data related to regular payroll processing, as well as data generated during off-cycle payroll runs, including bonus payments, corrections, payslip and tax statement files, and payroll reports. The data storage 140 can store data for payslip integration with other systems, such as employee self-service portals or accounting systems, which can include formatted payslip data, identifiers, or other integration-specific information. For temporal or time-related tasks, the data storage 140 can store time-series data for tracking employee attendance, accrued leave balances, and overtime calculations. The data storage 140 can manage data for shift scheduling, time-off requests, and holiday calendars for accurate processing and compliance with organizational policies or regulatory requirements. The data storage 140 can implement data structures, such as tables or key-value stores, to organize its stored data. The data storage 140 can support various data types, including integers, floating-point numbers, strings, dates, and Booleans. The computation engine 106 can access the data stored in the data storage 140 using mechanisms such as queries or lookups.

The computation engine 106 can include, interface with, communicate with, or otherwise utilize an interface controller 142. The interface controller 142 can be or include any script, file, program, application, set of instructions, or computer-executable code that can be configured to facilitate communication among the source application 102, the middleware 104, and the computation engine 106. The interface controller 142 can be similar to, and include any of the structure and functionality of, the interface controller 114 described in connection with the source application 102 or the interface controller 132 described in connection with the middleware 104.

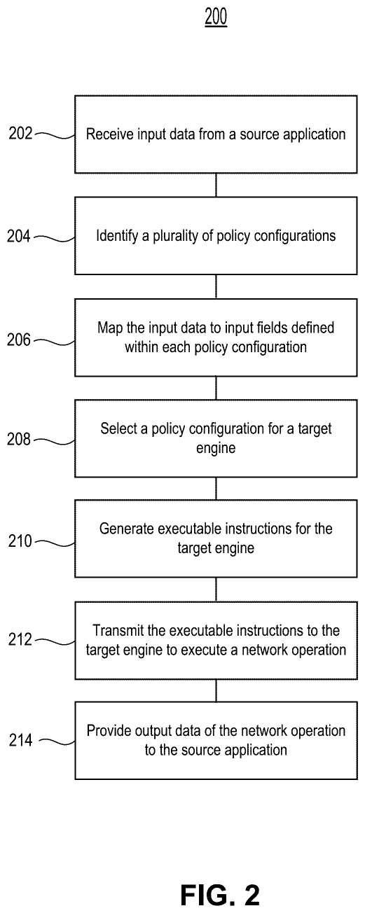

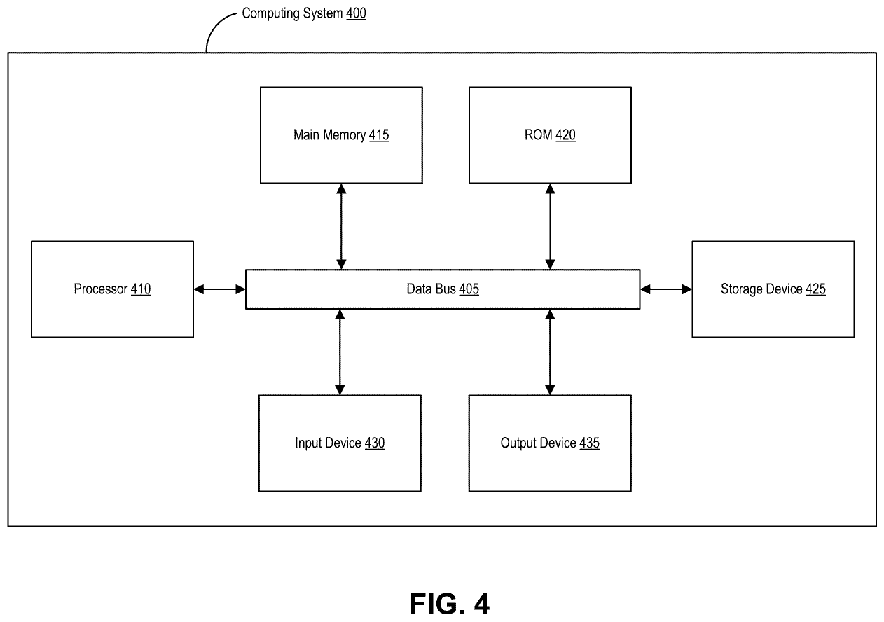

FIG. 2 depicts a method 200 of multi-layer configuration for computation engine integration in distributed computing systems. The method 200 can be implemented using a system 100, 400, or any other features discussed in FIG. 1 or FIG. 4. The method can include Acts 202-214. The Acts 202-214 can be executed in any order or sequence.

At 202, the method 200 can receive input data from a source application. In an aspect, the method can include receiving, from a source application, input data corresponding to a predefined data schema. The predefined data schema can include at least one of a comma-separated value (CSV) format, a tab-separated value (TSV) format, a fixed-width format, a JavaScript Object Notation (JSON) format, or an Extensible Markup Language (XML) format. In another aspect, the method can include receiving the input data from the source application via an application programming interface.

At 204, the method 200 can identify a plurality of policy configurations. In an aspect, the method can include identifying, based on the input data, a plurality of policy configurations. Each policy configuration can include a first layer defining a first subset of policies, a second layer defining a second subset of policies, and a third layer defining data associated with a profile data structure. These layers can be combined to generate or provide a context-specific policy for a given network operation.

At 206, the method 200 can map the input data to input fields defined within each policy configuration. In an aspect, the method can include mapping the input data to input fields defined within the first layer, the second layer, and the third layer of each policy configuration. In another aspect, the method can include mapping the input data to the input fields defined within the first layer, the second layer, and the third layer of each policy configuration based at least on a hierarchical mapping. The hierarchical mapping can include at least one of a partial mapping, a dynamic mapping, a rule-based mapping, or semantic mapping. In another aspect, the method can include generating a notification upon determining that a data element in the input data does not have a corresponding input field in any of the first, second, or third layers of the policy configuration. In another aspect, the method can include generating a notification upon determining that the input field does not have a corresponding data element in the input data.

At 208, the method 200 can select a policy configuration for a target engine. In an aspect, the method can include selecting, in response to mapping the input data to the input fields, a policy configuration for a target engine. In another aspect, the method can include identifying, based on the policy configuration, the target engine to execute a network operation.

At 210, the method 200 can generate executable instructions for the target engine. In an aspect, the method can include generating executable instructions for the computation engine identified as the target engine, based on the selected policy configuration, the type of network operation to be performed, system load, or other relevant criteria. In another aspect, the method can include generating, based on the policy configuration, executable instructions for the target engine. The executable instructions can include data transformed from the input data corresponding to the predefined data schema into a format compatible with the target engine. The format compatible with the target engine can include at least one of a serialized data format or a binary data format. In another aspect, the method can include generating the executable instructions to cause the target engine to execute a network operation in compliance with at least one of the first layer or the second layer of the policy configuration.

At 212, the method 200 can transmit the executable instructions to the target engine to execute a network operation. In an aspect, the method can include transmitting the executable instructions to the target engine to cause the target engine to execute the network operation. In another aspect, the method can include transmitting the executable instructions to the target engine via an application programming interface.

At 214, the method 200 can provide output data of the network operation to the source application. In an aspect, the method can include providing, to the source application, output data of the network operation executed by the target engine. The output data can be formatted or transformed by the middleware to facilitate compatibility with the source application's data structures.

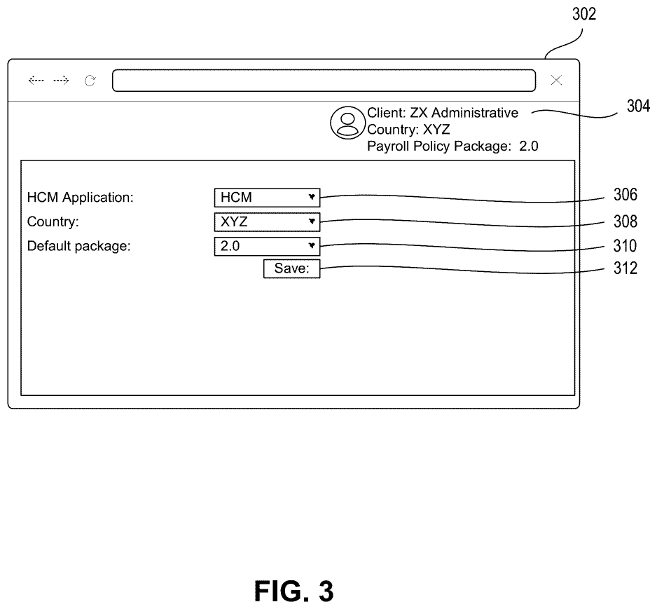

FIG. 3 depicts an example user interface 302, as described in connection with FIGS. 1-2. The user interface 302 can provide various interactive elements, including selection controls such as drop-down menus and action controls such as buttons, to facilitate user interaction and configuration. The user interface 302 can display client information 304, which can provide details about the client operating the HCM application (or the source application 102) or, in some embodiments, the client for which the network operation is to be performed. In this example user interface 302, the client is identified as “ZX Administrative” with a location in “Country: XYZ”. The user interface 302 can present an HCM application selection element 306 to allow the user to select a specific HCM application for configuration. The user interface 302 can present a country selection element 308 to allow the user to select the country for which the configuration or network operation is being applied. The user interface 302 can present a default package selection element 310 to allow the user to select a default policy package. In this example, the selected package “2.0” corresponds to a payroll policy package, though it can also correspond to other types of packages depending on the implementation. The user interface 302 can provide a save button 312 that the user can interact with. Upon receiving an interaction with the save button 312, the user interface 302 can be configured to transmit the settings, via the source application 102, to the middleware 104 for further processing. For example, when the user interacts with the drop-down menus 306, 308, and 310, and clicks the save button 312, the user interface 302 can transmit the selected values for the HCM application, country, and default package to the middleware 104, which can perform data mapping and parameter translation for the computation engine 106. The middleware 104 can use the received configuration data to select the appropriate policy configuration, generate executable instructions, and transmit those instructions to the computation engine 106. The computation engine 106 can execute the received instructions according to the selected policy configuration.

FIG. 4 depicts a block diagram of a computing system 400 for implementing the embodiments of the technical solutions discussed herein, in accordance with various aspects. FIG. 4 illustrates a block diagram of an example computing system 400, which can also be referred to as the computer system 400. Computing system 400 can be used to implement elements of the systems and methods described and illustrated herein. Computing system 400 can be included in and run any device (e.g., a server, a computer, a cloud computing environment, or a data processing system).

Computing system 400 can include at least one bus data bus 405 or other communication device, structure, or component for communicating information or data. Computing system 400 can include at least one processor 410 or processing circuit coupled to the data bus 405 for executing instructions or processing data or information. Computing system 400 can include one or more processors 410 or processing circuits coupled to the data bus 405 for exchanging or processing data or information along with other computing systems 400. Computing system 400 can include one or more main memories 415, such as a random access memory (RAM), dynamic RAM (DRAM), cache memory or other dynamic storage device, which can be coupled to the data bus 405 for storing information, data and instructions to be executed by the processor(s) 410. Main memory 415 can be used for storing information (e.g., data, computer code, commands, or instructions) during execution of instructions by the processor(s) 410.

Computing system 400 can include one or more read only memories (ROMs) 420 or other static storage device 425 coupled to the bus 405 for storing static information and instructions for the processor(s) 410. Storage devices 425 can include any storage device, such as a solid-state device, magnetic disk, or optical disk, which can be coupled to the data bus 405 to persistently store information and instructions.

Computing system 400 can be coupled via the data bus 405 to one or more output devices 435, such as speakers or displays (e.g., liquid crystal display or active matrix display) for displaying or providing information to a user. Input devices 430, such as keyboards, touch screens or voice interfaces, can be coupled to the data bus 405 for communicating information and commands to the processor(s) 410. Input device 430 can include, for example, a touch screen display (e.g., output device 435). Input device 430 can include a cursor control, such as a mouse, a trackball, or cursor direction keys, for communicating direction information and command selections to the processor(s) 410 for controlling cursor movement on a display.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors 410 in a multi-processing arrangement can also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter, including the operations described in this specification, can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
receive, from a source application, input data corresponding to a predefined data schema;
identify, based on the input data, a plurality of policy configurations, each policy configuration comprising:
a first layer defining a first subset of policies,
a second layer defining a second subset of policies, and
a third layer defining data associated with a profile data structure;
map the input data to input fields defined within the first layer, the second layer, and the third layer of each policy configuration;
select, in response to mapping the input data to the input fields, a policy configuration for a target engine;
generate, based on the policy configuration, executable instructions for the target engine; and
transmit the executable instructions to the target engine to cause the target engine to execute a network operation.

2. The system of claim 1, wherein the predefined data schema comprises at least one of a comma-separated value (CSV) format, a tab-separated value (TSV) format, a fixed-width format, a JavaScript Object Notation (JSON) format, or an Extensible Markup Language (XML) format.

3. The system of claim 1, wherein the executable instructions comprise data transformed from the input data corresponding to the predefined data schema into a format compatible with the target engine.

4. The system of claim 3, wherein the format compatible with the target engine comprises at least one of a serialized data format or a binary data format.

5. The system of claim 1, wherein the one or more processors are further configured to generate the executable instructions to cause the target engine to execute the network operation in compliance with at least one of the first layer or the second layer of the policy configuration.

6. The system of claim 1, wherein the one or more processors are further configured to map the input data to the input fields defined within the first layer, the second layer, and the third layer of each policy configuration based at least on a hierarchical mapping.

7. The system of claim 6, wherein the hierarchical mapping comprises at least one of a partial mapping, a dynamic mapping, a rule-based mapping, or semantic mapping.

8. The system of claim 1, wherein the one or more processors are further configured to identify, based on the policy configuration, the target engine to execute the network operation.

9. The system of claim 1, wherein the one or more processors are further configured to generate a notification upon determining that:
a data element in the input data does not have a corresponding input field in any of the first, second, or third layers of the policy configuration; or
the input field does not have a corresponding data element in the input data.

10. The system of claim 1, wherein the one or more processors are further configured to receive the input data from the source application via an application programming interface.

11. The system of claim 1, wherein the one or more processors are further configured to transmit the executable instructions to the target engine via an application programming interface.

12. A method, comprising:
receiving, by one or more processors, coupled with memory, from a source application, input data corresponding to a predefined data schema;
identifying, by the one or more processors, a plurality of policy configurations, each policy configuration comprising:
a first layer defining a first subset of policies,
a second layer defining a second subset of policies, and
a third layer defining data associated with a profile data structure;
mapping, by the one or more processors, the input data to input fields defined within the first layer, the second layer, and the third layer of each policy configuration;
selecting, by the one or more processors, in response to mapping the input data to the input fields, a policy configuration for a target engine;
generating, by the one or more processors, based on the policy configuration, executable instructions for the target engine;
transmitting, by the one or more processors, the executable instructions to the target engine to cause the target engine to execute a network operation; and
providing, by the one or more processors, to the source application, output data of the network operation executed by the target engine.

13. The method of claim 12, wherein the predefined data schema comprises at least one of a comma-separated value (CSV) format, a tab-separated value (TSV) format, a fixed-width format, a JavaScript Object Notation (JSON) format, or an Extensible Markup Language (XML) format.

14. The method of claim 12, wherein the executable instructions comprise data transformed from the input data corresponding to the predefined data schema into a format compatible with the target engine.

15. The method of claim 14, wherein the format compatible with the target engine comprises at least one of a serialized data format or a binary data format.

16. The method of claim 12, further comprising:
generating, by the one or more processors, the executable instructions to cause the target engine to execute the network operation in compliance with at least one of the first layer or the second layer of the policy configuration.

17. The method of claim 12, further comprising:
mapping, by the one or more processors, the input data to the input fields defined within the first layer, the second layer, and the third layer of each policy configuration based at least on a hierarchical mapping.

18. The method of claim 17, wherein the hierarchical mapping comprises at least one of a partial mapping, a dynamic mapping, a rule-based mapping, or semantic mapping.

19. The method of claim 12, further comprising:
identifying, by the one or more processors, based on the policy configuration, the target engine to execute the network operation.

20. A non-transitory computer readable medium including one or more instructions stored thereon and executable by a processor to:
receive, from a source application, input data corresponding to a predefined data schema;
identify, based on the input data, a plurality of policy configurations, each policy configuration comprising:
a first layer defining a first subset of policies,
a second layer defining a second subset of policies, and
a third layer defining data associated with a profile data structure;
map the input data to input fields defined within the first layer, the second layer, and the third layer of each policy configuration;
select, in response to mapping the input data to the input fields, a policy configuration for a target engine, the target engine identified based on the policy configuration; and
generate executable instructions for the target engine to cause the target engine to execute a network operation.
